(19) United States
(12) Patent Application Publication
(10) Pub. No.: US 2005/0247057 A1
(43) Pub. Date: Nov. 10, 2005

(54) Master cylinder unit for vehicles

(76) Inventors: Roberto Lavezzi, Brembate Di Sopra (IT); Gianangelo Pezzotta, Verdello (IT); Sem Sebastiano Locatelli, Villa D'Alme (IT)

Correspondence Address: HOGAN & HARTSON LLP;IP GROUP, COLUMBIA SQUARE, 555 THIRTEENTH STREET, N.W., WASHINGTON, DC, 20004, US

(21) Appl. No.: 10/512,196

(22) PCT Filed: Apr. 30, 2002
(86) PCT No.: PCT/IT02/00282

§ 371 Date: Jun. 6, 2005

(51) Int. Cl. F15B 7/00

(52) U.S. Cl. 60/533

(57) ABSTRACT

A master cylinder unit for vehicles comprises a cylinder body which houses a pressure chamber suitable for holding fluid which can be pressurized and a reservoir suitable for containing the fluid. The master cylinder unit is of the type with an attached reservoir connectible to the cylinder body by a fixing screw which is disposed inside the reservoir and comprises a portion of the fluid-bleeding circuit.

The subject of the present invention is a master cylinder unit for vehicles, for use as a brake and/or clutch master cylinder unit. The master cylinder unit is intended for use in the motorcycle field.

### BACKGROUND OF THE INVENTION

To ensure correct operation of a hydraulic braking circuit, the fluid contained therein must be free of air bubbles or other compressible gases. For this purpose, both the actuators (calipers and/or cylinders) and the brake or clutch master cylinder units are provided with bleeding circuits which enable any air present in the circuit to be discharged to the exterior.

It is known to form a bleeding circuit of this type in a manner such that the bleed vent of the circuit, from which the fluid mixed with air emerges during a bleeding operation, opens inside the reservoir. This prevents, for example, spillage of the fluid to the exterior during bleeding.

A master cylinder unit provided with a bleeding circuit which has a bleed vent inside the reservoir is described, for example, in the Applicant's document EP-A-1129918.

In the field of master cylinder units for vehicles, the solution of forming these master cylinder units in at least two separate parts, that is, a cylinder body and a reservoir connectible thereto (master cylinder with attached reservoir) is often adopted.

Known solutions for bleeding circuits provided with a bleed vent inside the reservoir have been found unsuitable or in any case impractical when the master cylinder unit is of the type with an attached reservoir.

In other words, the production of a bleeding circuit for master cylinder units with attached reservoirs has been found particularly difficult because of problems of sealing between the reservoir and the cylinder body, which result in a leakage of the fluid, amongst other things.

### OBJECT AND SUMMARY OF THE INVENTION

There is therefore a need to provide a master cylinder unit of the type with an attached reservoir provided with a bleeding circuit having a bleed vent inside the reservoir, which is reliable with regard to fluid leakage, particularly between the reservoir and the cylinder body.

The problem underlying the present invention is that of devising a master cylinder unit for vehicles which has structural and functional characteristics such as to satisfy the above-mentioned needs and at the same time to overcome the disadvantages mentioned with reference to the prior art.

This problem is solved by a master cylinder unit for vehicles according to claim 1. Further embodiments of the invention are described in the dependent claims.

### BRIEF DESCRIPTION OF THE DRAWINGS

Further characteristics and the advantages of the master cylinder unit according to the present invention will become clear from the following description of a preferred and non-limiting embodiment thereof, in which:

FIG. 1 is a partially-sectioned front view of a master cylinder unit comprising a cylinder body and a reservoir, connected by connection means,

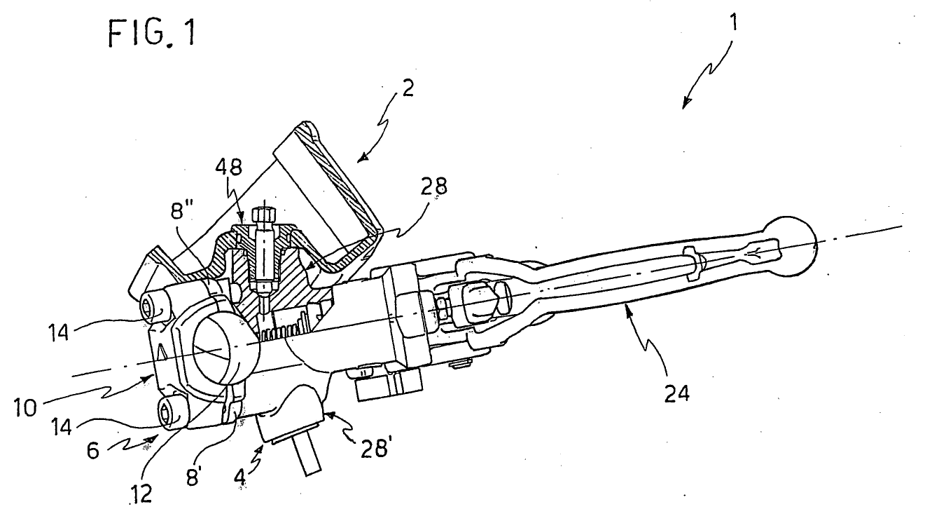

FIG. 2 shows the master cylinder unit of FIG. 1 with parts separated, in the same, partially-sectioned front view,

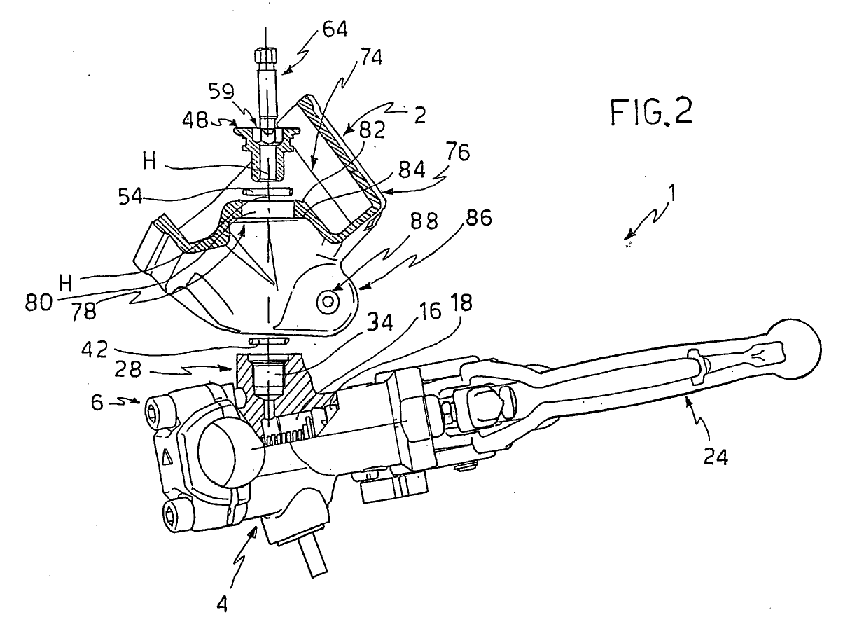

FIG. 3 shows the master cylinder unit of FIG. 1 in a further sectioned front view,

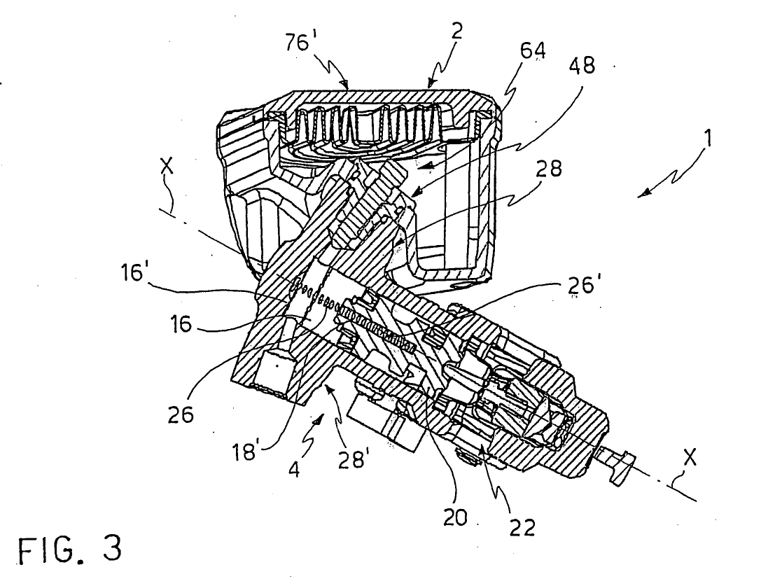

FIG. 4 is a sectioned front view of an enlarged detail of the master cylinder unit of FIG. 1,

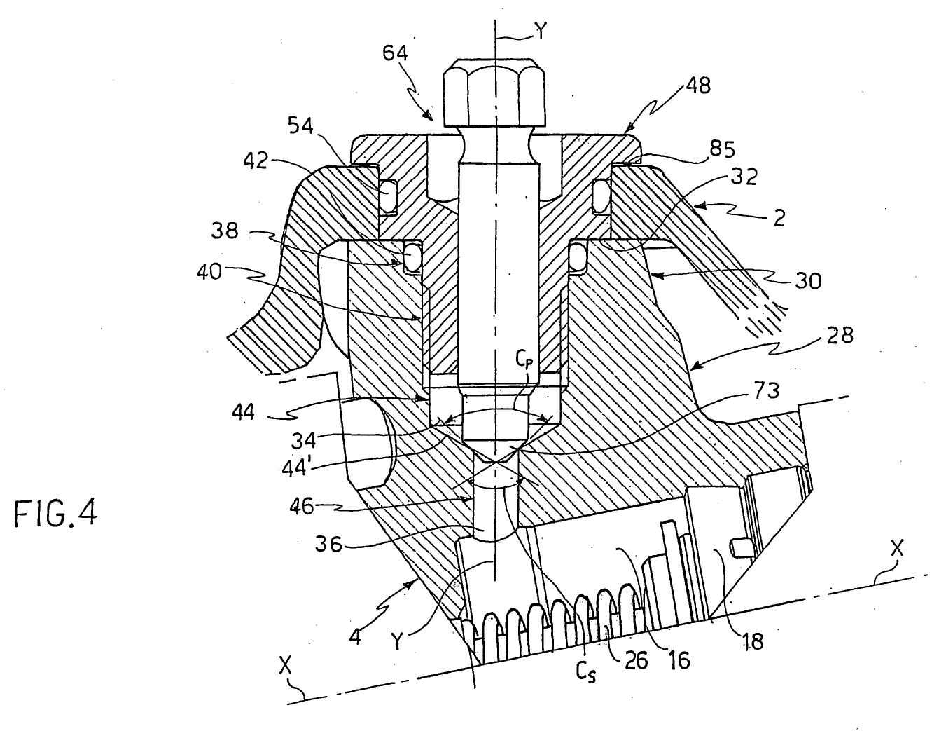

FIG. 5 is a partially-sectioned perspective view of a fixing screw and of a bleed nipple of the master cylinder unit of FIG. 1, and

FIG. 6 is a further partially-sectioned view of the master cylinder unit of FIG. 1.

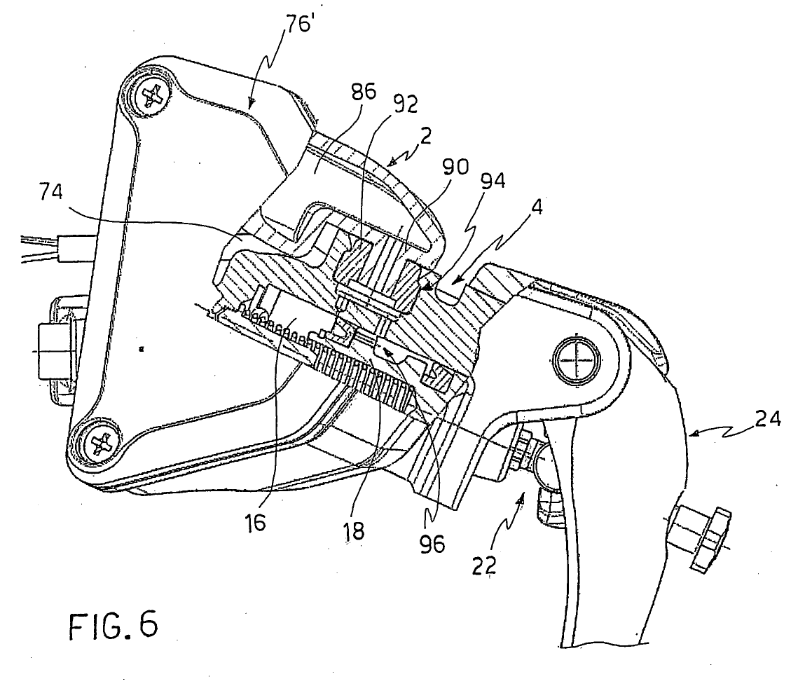

### DETAILED DESCRIPTION OF PREFERRED EMBODIMENTS

With reference to the appended drawings, a master cylinder unit for vehicles, for example, a master cylinder unit for hydraulic brakes for motorcycles, motor-sleds, and vehicles that can be steered by means of handlebars, or similar vehicles, is generally indicated 1.

The master cylinder 1 comprises a reservoir 2 and a cylinder body 4 to which the reservoir is connectible. The reservoir 2 is formed as a body separate from the cylinder body 4, so that the master cylinder 1 is of the type with an attached reservoir.

The cylinder body 4 preferably has engagement means 6 for engaging the cylinder body 4 on a handlebar (not shown) or on a support, in general.

In a preferred embodiment, the engagement means comprise engagement elements 8′ and 8″, spaced apart and extending from the cylinder body 4.

The engagement means also comprise a complementary engagement element 10 which can be connected to the engagement elements 8′ and 8″ in a manner such that a seat 12 for the coupling of the cylinder body 4 with the handlebar is formed between the engagement elements 8′ and 8″ and the complementary engagement element 10.

Clamping means 14, such as screws, bolts, or the like, form the connection between the complementary engagement element 10 and the engagement elements 8′ and 8″ so that, if a portion of the handlebar is clamped between them, a friction coupling is formed, which keeps the cylinder body 4 in position relative to the handlebar.

The cylinder body 4 also has a pressure chamber 16 inside the cylinder body and defined between a base wall 16′ and a base 18′ of a piston 18 mounted for sliding in a leaktight manner and movable along an axis X-X in the pressure chamber.

An operating end 20 of the piston 18, remote from its base 18′, preferably cooperates with a thrust mechanism 22 associated with an operating lever 24 articulated to the cylinder body 4.

In a preferred embodiment, the piston 18 cooperates with resilient biasing means which are preferably formed by a helical spring 26 partially housed in a spring seat 26′ provided in the piston 18 at the end having the base 18′. The spring 26 is in abutment with the base wall 16′ of the pressure chamber 16.

The piston 18, which cooperates with the thrust mechanism 22 operated by the lever 24, as well as the spring 26, form an embodiment of pressurization means which can pressurize the fluid contained in the pressure chamber 16 of the piston 18.

The cylinder body 4 also comprises at least one protuberance 28 which projects from the cylinder body and can be connected to the reservoir 2.

In a preferred embodiment, the cylinder body 4 comprises two substantially similar protuberances 28 and 28′ arranged symmetrically with respect to a plane of symmetry of the cylinder body 4 in which the axis X-X of the cylinder body 4 lies.

The protuberance 28 extends from the cylinder body 4 substantially along a protuberance axis Y-Y.

The protuberance 28 has an annular coupling surface 32, which is advantageously flat, at a free end 30 of the protuberance 28 which is to be connected to the reservoir 2. The coupling surface preferably lies in a plane perpendicular to the protuberance axis Y-Y.

The protuberance 28 has an internal cavity 34 which is open at the free end 30 of the protuberance and, at the opposite end, communicates with the pressure chamber 16 of the cylinder body 4 by means of an aperture 36.

The cavity preferably extends along an axis defined by the protuberance axis Y-Y and has a substantially cylindrical shape.

In a preferred embodiment, the cavity 34 is defined by a series of portions which extend along the protuberance axis Y-Y.

A first cylindrical portion 38 is formed at the mouth of the cavity 34, starting from the free end 30 of the protuberance 28, and is followed, towards the aperture 36 for communication with the pressure chamber 16, by a second, threaded cylindrical portion 40.

The threaded cylindrical portion 40 has a smaller diameter than the first cylindrical portion 38 so that the first cylindrical portion 38 is configured as a first half seal seat for a first sealing ring 42.

A connecting portion 44 extends from the threaded portion 40 and has a frustoconical part 44′. The frustoconical part 44′ is defined geometrically by a taper Cs, referred to as the seat taper.

The frustoconical part 44′ of the cavity 34 is connected directly to a last, cylindrical portion 46 of the cavity 34 which communicates with the pressure chamber 16 of the cylinder body 4 through the aperture 36.

The cavity 34 of the protuberance 28 can house, at least partially, a fixing screw 48 for fixing the reservoir 2 to the cylinder body 4.

The fixing screw 48 extends in a substantially cylindrical configuration along a screw axis S-S which coincides with the protuberance axis Y-Y in a configuration in which the fixing screw 48 is fitted in the cavity 34 of the protuberance 28.

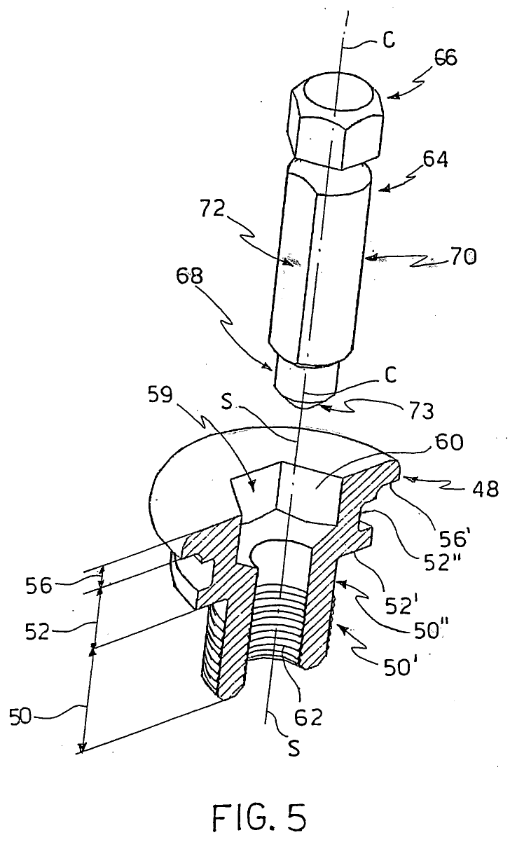

A series of substantially cylindrical parts of axis S-S can be seen in the external structure of the fixing screw 48 (FIG. 5).

In a first, screwing part 50, which is housed completely in the cavity 34 in the configuration in which the fixing screw 48 is fitted in the cavity, it is possible to recognize a threaded part 50′ to be screwed into the threaded portion 40 of the cavity 34 and a cylindrical part 50″ having the same diameter as the threaded part and having a substantially smooth surface.

The screwing part 50 adjoins a circumferential projection 52 having a diameter larger than the diameter of the screwing part 50, so as to define an undercut or rear head surface 52′, for example, an annular abutment surface.

An annular groove 52″ defined in the circumferential projection 52 forms a second sealing seat for a second sealing ring 54.

Finally, the external structure of the fixing screw 48 has a head 56 with a diameter larger than the diameter of the circumferential projection 52 so as to define an annular clamping surface 56′ facing the second seal seat 52″ of the fixing screw.

The fixing screw 48 has a through-hole 59 comprising a hexagonal seat 60 suitable for coupling with a workshop tool such as a hexagonal wrench for screwing the fixing screw 48 into the cavity 34 of the protuberance 28 of the cylinder body 4, and communicating with a threaded part 62 for housing a bleed nipple 64.

The bleed nipple 64 extends along a nipple axis C-C and has a substantially cylindrical shape. In a configuration in which the bleed nipple 64 is fitted in the fixing screw 48, the nipple axis C-C coincides with the screw axis S-S, and hence with the protuberance axis Y-Y.

A threaded part 70 for screwing into the threaded part 62 of the fixing screw 48 can be seen between a screw head 66, preferably hexagonal, and an end shank 68 of the nipple 64.

The threaded part 70 has at least one flat surface 72 which preferably extends along the entire axial length of the threaded part 70.

The end shank 68 of the bleed nipple 64 terminates in a frustoconical portion 73 defined geometrically by a taper Cp, referred to as the abutment taper.

The abutment taper Cp of the frustoconical portion 73 of the bleed nipple 64 is advantageously less than the seat taper Cs of the frustoconical part 44′ of the cavity 34 of the cylinder body 4.

In a preferred embodiment, the seat taper Cs is preferably 120° and the abutment taper Cp is preferably 90°. These taper values are intended to be purely indicative. In particular, in a further embodiment, the seat taper Cs adopts a limit value of 180°, that is, the part 44′ of the cavity 34 is configured as a substantially cylindrical part.

The fixing screw 48, advantageously associated with the first sealing ring 42 and with the second sealing ring 54, as well as the protuberance 28 of the cylinder body 4 which has the cavity 34 with which the fixing screw can be associated, form connection means between the reservoir 2 and the cylinder body 4.

The reservoir 2 comprises a reservoir chamber 74 for holding the fluid, defined by a reservoir wall 76 which is configured as a shell around the reservoir chamber 74 and can be associated with a cover 76′ which closes it.

A bearing portion 78 of the reservoir wall 76 has a hole 80, having a hole axis H-H, suitable for engaging the circumferential projection 52 of the fixing screw 48.

In the region of the hole 80, the bearing portion 78 of the reservoir wall 76 has an inner annular surface 82 facing the reservoir chamber 74 and an outer annular surface 84 opposite the inner annular surface.

The inner annular surface 82 and the outer annular surface 84 of the bearing portion 78 are substantially flat and parallel to one another.

The inner annular surface 82 of the bearing portion 78 has a circumferential lip 85 which surrounds the mouth of the hole 80 in the reservoir wall 76. A cross-section of the circumferential lip 85, taken in a plane which contains the axis of the hole H-H of the reservoir 2, is arcuate, of discontinuous outline or, as in the embodiment described, triangular.

In the region of the hole 80, the bearing portion 78 of the reservoir wall 76 has an axial thickness, in the direction defined by the hole axis H-H, which is smaller than or at most equal to the axial length of the circumferential projection 52 of the fixing screw 48, defined along the screw axis S-S.

The reservoir 2 further comprises a connecting chamber 86 from the walls of which a hollow tubular element 90 extends.

In the configuration in which the reservoir 2 is mounted on the cylinder body 4, the tubular element 90 advantageously cooperates with a seal 92 disposed in a seal seat 94 of the cylinder body to form a duct for the admission of fluid from the reservoir chamber 74 of the reservoir 2 to the pressure chamber 16 of the cylinder body 4.

In an assembled configuration of the components of the master cylinder unit 1, the reservoir 2 is connected to the cylinder body 4 in a manner such that the hole 80 formed in the reservoir wall 76. faces the cavity 34 of the protuberance 28 of the cylinder body 4.

In other words, the bearing portion 78 of the reservoir wall 76 is brought into abutment with the protuberance 28 of the cylinder body 4 in a manner such that the outer annular surface 84 of the bearing portion 78 bears on the annular coupling surface 32 of the protuberance 28.

The position of the annular coupling surface 32 of the protuberance 28 relative to the seat 94 of the cylinder body 4 intended for the seal 92, and the position of the outer annular surface 84 of the reservoir 2 relative to the tubular element 90 of the reservoir are suitable for locating the tubular element 90 relative to the seal 92 housed in the seat 94 of the cylinder body 4, once the reservoir 2 is bearing on the protuberance 28.

In other words, the relative positioning between the annular coupling surface 32 and the seat 94 of the cylinder body 4 and between the outer annular surface 84 and the tubular element 90 of the reservoir are such as to enable the tubular element 90 to be aligned with the seat 94 of the cylinder body 4 so as to form an inlet duct for the fluid from the reservoir 2 to the pressure chamber 16 of the cylinder body 4.

In the above-mentioned assembled configuration of the master cylinder unit 1, the first sealing ring 42 is disposed in the first half seal seat 38 of the cavity 34 of the protuberance 28 and the second sealing ring 54 is disposed in the annular groove 52″ of the fixing screw 48.

The screwing part 50 of the fixing screw 48 extends through the hole 80 of the reservoir 2 and is screwed into the threaded connecting portion 40 of the cavity 34 so that the bearing portion 78 of the reservoir 2 is restrained between the head 56 of the fixing screw 48 and the annular coupling surface 32 of the protuberance 28.

The cylindrical part 50″ and the annular abutment surface 52′ of the fixing screw 48 cooperate with the first half seal seat 38 of the cavity 34, completing the seal seat for the first sealing ring 42.

Tightening of the fixing screw 48 locks the reservoir 2 in position.

In particular, any slight misalignment between the tubular element 90 and the seal 92 due, for example, to manufacturing tolerances of the parts or assembly tolerances, are taken up by the deformable seal 92.

The inner annular surface 82 of the bearing portion 78 of the reservoir 2 is coupled with the annular clamping surface 56′ of the head 56 of the fixing screw 48 and the outer annular surface 84 of the bearing portion 78 of the reservoir 2 is coupled with the annular coupling surface 32 of the protuberance 28.

Moreover, the diameter of the circumferential projection 52 of the fixing screw 48 achieves coupling with the hole 80 of the reservoir 2 so that the screwing of the fixing screw 48 engaged with the reservoir 2 at the same time achieves centring of the reservoir relative to the protuberance 28.

During the screwing of the fixing screw 48 into the cavity 34 of the cylinder body 4, the annular abutment surface 52′ of the fixing screw is brought into abutment with the annular coupling surface 32 of the protuberance 28, ensuring firm and secure fixing by means of a clamping torque which ensures fixing even after successive operations performed on the bleed nipple.

Any differences between the axial lengths of the circumferential projections 52 of different screws 48 due to production tolerances of the screws, and the axial extents of the bearing portion 78 of the reservoir 2 are advantageously taken up by a greater or lesser degree of deformation of the circumferential lip 85 disposed on the inner annular surface 82 of the reservoir 2, due to the tightening of the fixing screw 48.

The through-hole 59 of the fixing screw 48 and, at least partially, the cavity 34 of the protuberance 28, form a bleeding circuit for the master cylinder unit 1, constituting a duct between the reservoir chamber 74 of the reservoir 2 and the pressure chamber 16 of the cylinder body 4.

The bleeding circuit is closed by the bleed nipple 64 which can be screwed into the through-hole 59 of the fixing screw 48.

In a closure position, the bleed nipple 64 is screwed up so that the end shank 68 of the nipple is brought into abutment with the mouth of the last cylindrical portion 46 of the cavity 34.

In particular, the frustoconical portion 73 of the end shank 68 of the bleed nipple 64 is brought into abutment with the angle between the frustoconical part 44′ of the connecting portion 44 of the cavity 34 and the last cylindrical portion 46 of the cavity 34. By virtue of the difference between the seat taper Cs of the frustoconical portion 44′ and the abutment taper Cp of the frustoconical portion 73 of the end shank 68, the bleed nipple closes the bleeding circuit.

In an open position, the bleed nipple is not in abutment with the mouth of the last cylindrical portion 46 of the cavity 34 so that the bleeding circuit puts the reservoir chamber 74 into communication with the pressure chamber 16 of the cylinder body 4 by virtue of the flat surface 72 provided along the nipple.

The fixing screw 48, which forms connection means between the reservoir 2 and the cylinder body 4, thus also comprises at least a portion of the bleeding circuit of the master cylinder unit 1.

In other words, the fixing screw 48 forms means for connecting the reservoir 2 to the cylinder body 4, preventing movement of the reservoir in the axial direction defined by the protuberance axis Y-Y, and centring the reservoir relative to the protuberance 28 and, at the same time, comprises a portion of the bleeding circuit formed by the through-hole 59 of the fixing screw.

In this situation, the bleeding circuit forms a duct between the pressure chamber 16 of the cylinder body 4 and an atmosphere outside the pressure chamber, constituted by the reservoir chamber 74 of the reservoir 2.

The fixing screw 48 also comprises fluid sealing means comprising the annular groove 52″ in which the second sealing ring 54 can be housed and the annular abutment surface 52′, together with the cylindrical part 50″ which, in the assembled configuration, cooperate with the first cylindrical portion 38 of the cavity 34 of the cylinder body 4, defining the seat of the first sealing ring 42.

The sealing means perform the dual function of sealing with respect to the connection between the reservoir 2 and the cylinder body 4 and sealing of the bleeding circuit.

During normal use of a braking or clutch system comprising the master cylinder unit 1, the pressure chamber 16 is supplied with fluid through the fluid-inlet duct defined by the connecting chamber 86 of the reservoir 2, by the cavity through the tubular element 90 associated therewith, and by fluid-inlet apertures 96 provided in the wall of the cylinder body 4.

Operation of the lever 24 of the master cylinder unit 1, for example, in the course of a braking operation, produces an increase in the pressure of the fluid in the pressure chamber 16, in the hydraulic braking circuit, and hence in the actuators associated therewith. During normal use, the bleed nipple 64 thus closes the bleeding circuit so that the desired increase in the pressure of the fluid in the pressure chamber 16 can be brought about.

During a maintenance operation on a braking or clutch system provided with the master cylinder unit 1, or during the installation of the master cylinder unit 1 in a vehicle, when the cover 76′ is separated from the reservoir 2, the bleed nipple 64 is readily and conveniently accessible.

During a bleeding operation, the lever 24 of the master cylinder unit 1 is operated, in practice reaching a travel limit, and the nipple is unscrewed, adopting the open position which enables the pressure chamber 16 of the cylinder body 4 to be put into communication with the reservoir chamber 74 of the reservoir 2.

The air or gas is dispelled outside the reservoir by rising along the bleeding circuit from the pressure chamber 16 to the reservoir chamber 74 which is left open to the atmosphere.

Any spurts of fluid, possibly entrained by the rising air or gas are reabsorbed into the fluid which is present in the reservoir, since the free surface of the fluid in the reservoir chamber 74 is generally above the mouth of the through-hole 59 of the fixing screw 48 which forms the bleed vent for the fluid.

The bleed nipple 64 is screwed up again, bringing it to the closure position and the lever 24 is released.

The above-mentioned maintenance operations are repeated several times, if necessary, to eliminate completely the air or gas which is present.

Unusually, the master cylinder unit 1 according to the invention forms a master cylinder unit of the type with an attached reservoir which has a bleeding circuit with a bleed vent inside the reservoir, and which is reliable with regard to fluid leakage.

The above-mentioned master cylinder unit overcomes the disadvantages due to the leakage of the fluid between the reservoir and the cylinder body, by virtue of the combination of the connection means between the reservoir and the cylinder body, and the bleeding circuit which eliminates the need for further ducts and apertures between the reservoir and the cylinder body, which form the bleeding circuit.

The connection means are also combined with the sealing means.

Moreover, leakage of fluid between the reservoir and the cylinder body is prevented by the abutment between the annular abutment surface of the fixing screw and the annular coupling surface of the protuberance.

The circumferential lip provided in the inner annular surface of the bearing portion of the reservoir advantageously enables any working tolerances of the fixing screw to be taken up, permitting abutment between the annular abutment surface of the fixing screw and the annular coupling surface of the protuberance, as well as between the annular clamping surface of the fixing screw and the inner annular surface of the connecting portion of the reservoir. This double abutment is advantageously achieved by plastic deformation of the circumferential lip as a result of the tightening of the head of the fixing screw into the cavity of the cylinder body.

Naturally, in order to satisfy contingent and specific requirements, a person skilled in the art may apply many modifications and variations to the above-described master cylinder unit.

In a further variant, the bleeding circuit of the master cylinder unit, which is at least partially included in connecting means between the reservoir and the cylinder body, also extends outside the reservoir chamber. Preferably, the bleeding circuit extends outside the reservoir, being included in a fixing screw projecting from the reservoir chamber towards the outside atmosphere, for example, through the cover of the reservoir and/or the reservoir walls.

Naturally, these variants are also intended to be included within the scope of protection of the invention as defined by the appended claims.

1. A master cylinder unit for vehicles, comprising:
a cylinder body which houses a pressure chamber for holding fluid which can be pressurized by pressurization means,
a reservoir for containing the fluid, connectible to the pressure chamber in a manner such as to permit a flow of fluid, in order to supply the pressure chamber with fluid, and releasably connectible to the cylinder body by connection means,
a. bleeding circuit disposed between the pressure chamber of the cylinder body and an atmosphere outside the pressure chamber and suitable for putting the pressure chamber into communication with the outside atmosphere in the course of a bleeding operation,
the means for connecting the reservoir to the cylinder body comprising at least a portion of the bleeding circuit.

2. A master cylinder unit according to claim 1 in which the means for connecting the reservoir to the cylinder body comprise at least one fixing screw.

3. A master cylinder unit according to claim 2 in which the at least one portion of the bleeding circuit extends through the fixing screw.

4. A cylinder unit according to claim 3 in which the at least one portion of the bleeding circuit is formed by a through-hole provided in the fixing screw

5. A master cylinder unit according to claim 4 in which the through-hole comprises a hexagonal seat suitable for coupling with a workshop tool for screwing the fixing screw.

6. A master cylinder unit according to claim 4 in which the through-hole of the fixing screw comprises a threaded part.

7. A master cylinder unit according to claim 2 in which the fixing screw comprises a circumferential projection for centring the reservoir relative to the cylinder body.

8. A master cylinder unit according to claim 2 in which the fixing screw is suitable for coupling with a bleed nipple suitable for closing and/or opening the bleeding circuit.

9. A master cylinder unit according to claim 8 in which the bleed nipple is a substantially cylindrical body having a predefined nipple axis (C-C) and provided with a threaded part suitable for being screwed into the through-hole of the fixing screw.

10. A master cylinder-unit according to claim 9 in which the bleed nipple has at least one flat surface which extends in the direction of the nipple axis (C-C) throughout the axial extent of the threaded part of the bleed nipple.

11. A master cylinder unit according to claim 7 in which the bleed nipple has an end shank terminating in a frustoconical portion having a predefined abutment taper (Cp).

12. A master cylinder unit according to claim 1 in which the atmosphere outside the pressure chamber of the cylinder body comprises the reservoir chamber of the reservoir.

13. A master cylinder unit according to claim 2 in which the fixing screw comprises a head which can interact with a bearing portion of the reservoir, in a configuration in which the reservoir is mounted on the cylinder body, in order to connect the reservoir to the cylinder body.

14. A master cylinder unit according to claim 13 in which the head has an annular clamping surface which interacts with the bearing portion of the reservoir.

15. A master cylinder unit according to claim 1, further comprising locating means for locating the reservoir relative to the cylinder body to allow connection such as to permit a flow of fluid between the reservoir and the cylinder body.

16. A master cylinder unit according to claim 15 in which the locating means comprise a bearing portion of the wall of the reservoir for locating the reservoir on the cylinder body.

17. A master cylinder unit according to claim 16 in which the bearing portion has a through-hole through the reservoir wall.

18. A master cylinder unit according to claim 15 in which the locating means comprise at least a second portion of the bleeding circuit.

19. A master cylinder unit according to claim 15 in which the locating means comprise at least one protuberance which projects from the cylinder body, extending along a protuberance axis (Y-Y).

20. A master cylinder unit according to claim 15 in which the locating means comprise two protuberances which project from the cylinder body, each protuberance extending along a protuberance axis (Y-Y) and the protuberances being arranged symmetrically with respect to the cylinder body.

21. A master cylinder unit according to claim 20 in which the two protuberances are intended for interchangeable connection to the reservoir or to the output tube of the pressure chamber.

22. A master cylinder unit according to claim 19 in which the protuberance has an annular coupling surface in the region of a free end of the protuberance A which is intended for coupling with the reservoir.

23. A master cylinder unit according to claim 22 in which the annular coupling surface lies in a plane substantially perpendicular to the protuberance axis (Y-Y).

24. A master cylinder unit according to claim 23 in which the protuberance has a cavity which is open at the free end of the protuberance.

25. A master cylinder unit according to claim 24 in which the cavity is suitable for housing the fixing screw by screwing in order to connect the reservoir to the cylinder body.

26. A master cylinder unit according to claim 24 in which the cavity communicates with the pressure chamber of the cylinder body.

27. A master cylinder unit according to claim 24 in which the cavity has, at its end that can be coupled with the reservoir, a first half seal seat for housing a first sealing ring.

28. A master cylinder unit according to claim 24 in which the cavity has a frustoconical part having a predefined seat taper (Cs).

29. A master cylinder unit according to claim 11 in which the abutment taper (Cp) of the frustoconical portion of the bleed nipple is less than the seat taper (Cs) of the frustoconical part of the cavity.

30. A master cylinder unit according to claim 29 in which the abutment taper (Cp) of the frustoconical portion of the bleed nipple is less than the seat taper (Cs) of the frustoconical part of the cavity in order to form a fluid-tight seal between the reservoir and the pressure chamber of the cylinder body when the bleed nipple is in a closure position.

31. A master cylinder unit according to claim 30 in which the abutment taper (Cp) of the frustoconical portion of the bleed nipple is 90° and the seat taper (Cs) of the frustoconical part of the cavity is 120°.

32. A master cylinder unit according to claim 1 in which the reservoir has a reservoir chamber for holding the fluid, defined by reservoir walls.

33. A master cylinder unit according to claim 32 in which the reservoir has a hole through the reservoir walls, the hole having a hole axis H-H and being suitable for engaging the fixing screw at least partially.

34. A master cylinder unit according to claim 33 in which the hole is surrounded by a circumferential lip on the side facing the reservoir chamber.

35. A master cylinder unit according to claim 34 in which the circumferential lip has a triangular cross-section in a plane which contains the hole axis H-H.

36. A master cylinder unit according to claim 35 in which, in the configuration in which the reservoir is mounted on the cylinder body, the circumferential lip is deformed by the connection means.

37. A master cylinder unit according to claim 1 in which the cylinder body has engagement means suitable for the engagement of the cylinder body on a handlebar or on a support.

38. A brake comprising a master cylinder unit according to any one of claims 1 to 37.

39. A clutch comprising a master cylinder unit according to any one of claims 1 to 37.
